(19) United States
(12) Patent Application Publication
(10) Pub. No.: US 2008/0258693 A1
(43) Pub. Date: Oct. 23, 2008

(54) Method for Controlling an Electromagnetic Retarder and System Including Retarder and a Control Unit

(76) Inventors: Bruno Dessirier, Saint Germain en Laye (FR); Serge Newiadomy, Clichy Sous Bois (FR); Mamy Rakotovao, Le Kremlin Bicetre (FR)

Correspondence Address: BERENATO, WHITE & STAVISH, LLC, 6550 ROCK SPRING DRIVE, SUITE 240, BETHESDA, MD, 20817, US

(21) Appl. No.: 12/091,067

(22) PCT Filed: Dec. 6, 2006
(86) PCT No.: PCT/FR2006/002663

§ 371 Date: Jul. 7, 2008

(30) Foreign Application Priority Data
Dec. 7, 2005 (FR) 0553761

(51) Int. Cl. H02P 15/00; H02K 7/104

(52) U.S. Cl. 322/29; 310/93

(57) ABSTRACT

A method for controlling an electromagnetic retarder from a control unit said retarder including an electrical generator. The inventive method is used to determine an excitation current intensity to be injected into the primary coils of the generator of the retarder, said retarder including a rotary shaft bearing the secondary windings of the generator a n d field coils which are supplied b y the secondary windings. The rotation speed of the rotary shaft is taken into account in order to select a lower intensity if the rotation speed of the shaft is higher. The invention is suitable for use in the field of electromagnetic retarders which are intended for heavy vehicles such as trucks.

### FIELD OF THE INVENTION

The invention concerns a method of controlling an electromagnetic retarder comprising a current generator. The invention also concerns a system including such an electromagnetic retarder and its control box.

The invention applies to a retarder capable of generating a retarding resisting torque on a main or secondary transmission shaft of a vehicle that it equips, when this retarder is actuated.

### PRIOR ART

Such an electromagnetic retarder comprises a rotary shaft that is coupled to the main or secondary transmission shaft of the vehicle in order to exert on it the retarding resisting torque in particular for assisting the braking of the vehicle.

The retarding is generated with field coils supplied with DC current in order to produce a magnetic field in a metal piece made from ferromagnetic material, in order to make eddy currents appear in this metal piece.

The field coils can be fixed so as to cooperate with at least one metal piece made from movable ferromagnetic material having the general appearance of a disc rigidly secured to the rotary shaft.

In this case, these field coils are generally oriented parallel to the rotation axis and disposed around this axis, facing the disc, while being secured to a fixed plate. Two successive field coils are supplied electrically in order to generate magnetic fields in opposite directions.

When these field coils are supplied electrically, the eddy currents that they generate in the disc to their effect oppose the cause that gives rise to them, which produces a resisting torque on the disc and therefore on the rotary shaft, in order to slow down the vehicle.

In this embodiment, the field coils are supplied electrically by a current coming from the electrical system of the vehicle, that is to say for example from a battery of the vehicle. However, in order to increase the performance of the retarder, recourse is had to a design in which a current generator is integrated in the retarder.

Thus, according to another design known from the patent documents EP0331559 and FR1467310, the electrical supply to the field coils is provided by a generator comprising primary stator coils supplied by the vehicle system, and secondary rotor coils fixed to the rotating shaft.

The field coils are then fixed to the rotating shaft while being radially projecting, so that they turn with the rotary shaft in order to generate a magnetic field in a fixed cylindrical jacket that surrounds them.

A rectifier such as a diode bridge rectifier is interposed between the secondary rotor windings of the generator and the field coil, in order to convert the alternating current delivered by the secondary windings of the generator into a DC current supplying the field coils.

Two radial field coils consecutive around the rotation axis generate magnetic fields in opposite directions, one generating a field oriented centrifugally, the other a field oriented centripetally.

In operation, the electrical supply to the primary coils enables the generator to produce the supply current to the field coils, which gives rise to eddy currents in the fixed cylindrical jacket so as to generate a resisting torque on the rotary shaft, which slows the vehicle.

In order to reduce the weight and increase further the performance of such a retarder, it is advantageous to couple it to the transmission shaft of the vehicle by means of a speed multiplier, in accordance with the solution adopted in the patent document EP1527509.

The rotation speed of the retarder shaft is then multiplied compared with the rotation speed of the transmission shaft to which it is coupled. This arrangement significantly increases the electrical power delivered by the generator and therefore the power of the retarder.

### OBJECT OF THE INVENTION

The aim of the invention is a method of determining the intensity of the excitation current of the primary coils of an electromagnetic retarder for improving its performance and reliability.

To this end, the object of the invention is a method of controlling a retarder from a control box, in order to determine an excitation current intensity to be injected into primary coils of a retarding generator, this retarder comprising a rotary shaft carrying secondary windings of the generator and field coils supplied by these secondary windings, characterised in that it consists of taking into account the rotation speed of the rotary shaft in order to choose an excitation current intensity that is lower, the higher the rotation speed of the shaft.

The intensity can thus be determined in the control box, from a nomogram corresponding to a maximum acceptable intensity curve that depends on the rotation speed of the rotating shaft, this curve being decreasing.

In the case of a high speed of the rotating shaft, the intensity of the excitation current injected into the primary coils is thus reduced so as to prevent deterioration of the field coils and/or secondary windings of the generator.

At low speed of the rotating shaft a current having a high intensity can be injected into the primary coils in order to increase the resisting torque exerted by the retarder without risk of damage to the field coils.

The invention also concerns a method as defined above, consisting of choosing an intensity for which the generator delivers, at the rotation speed in question, an electric power lower than a maximum electric power acceptable for the field coils.

The invention also concerns a method as defined above, consisting of choosing an intensity lower than a maximum acceptable intensity depending on the speed of rotation of the shaft and corresponding to the maximum electric power acceptable for the field coils.

The invention also concerns a method as defined above, in which the maximum electric power acceptable for the field coils or the maximum acceptable intensity depends on at least a temperature value signifying the thermal state of the retarder.

The invention also concerns a method as defined above, consisting of taking into account a control signal for the retarder, in order to choose an intensity proportional to the maximum acceptable intensity according to a proportion factor corresponding to the retarder control signal.

The invention also concerns a system including a electromagnetic retarder comprising a rotary shaft carrying secondary windings of a current generator and field coils supplied by the secondary windings of the generator, a stator equipped with primary coils of this generator, a sensor for the speed of rotation of the rotary shaft and a control box connected to the speed sensor and/or to the temperature probe for taking into account the speed of rotation of the rotary shaft in order to choose an excitation current intensity that is lower, the higher the speed of rotation of the shaft.

The invention also concerns a system as defined above, comprising at least one temperature probe delivering a signal representing the thermal state of the retarder.

The invention also concerns a system as defined above, in which the control box is connected to the temperature probe.

### BRIEF DESCRIPTION OF THE DRAWINGS

The invention will now be described in more detail and with reference to the accompanying drawings, which illustrate an embodiment thereof by way of non-limitative example.

FIG. 1 is an overall view with a local cutaway of an electromagnetic retarder to which the invention applies;

FIG. 2 is schematic representation of the electrical components of the retarder according to the invention;

FIG. 3 is a curve representing the maximum acceptable intensity as a function of the speed of rotation of the rotary shaft.

### DESCRIPTION OF EMBODIMENTS OF THE INVENTION

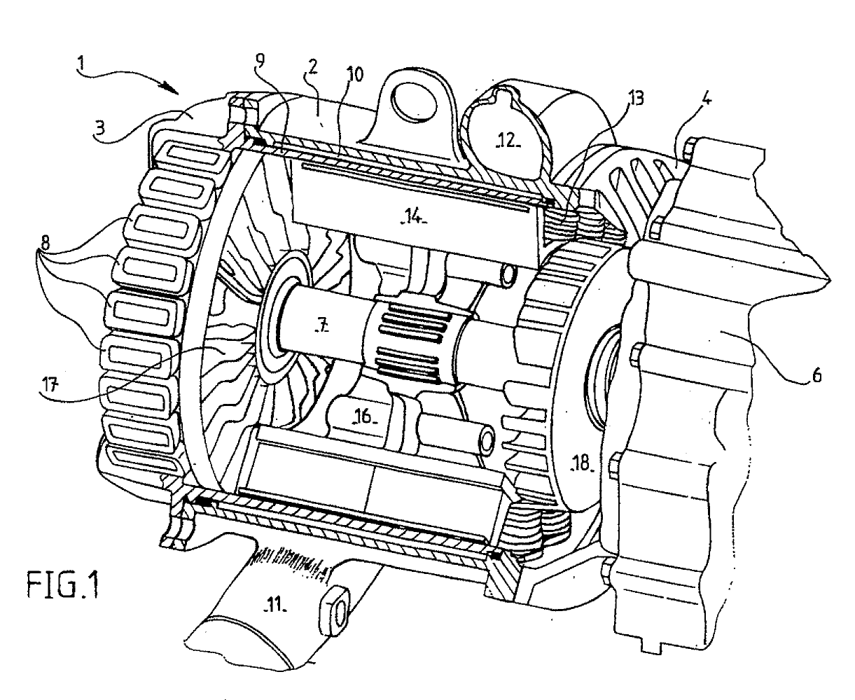

In FIG. 1, the electromagnetic retarder 1 comprises a main casing 2 with a cylindrical shape overall having a first end closed by a cover 3 and a second end closed by a coupling piece 4 by means of this retarder 1 is fixed to a gearbox casing either directly or indirectly, here via a speed multiplier referenced 6.

This casing 2, which is fixed, encloses a rotary shaft 7 that is coupled to a transmission shaft, not visible in the figure, such as a main transmission shaft to the vehicle wheels, or secondary such as a secondary gearbox output shaft via the speed multiplier 6. In a region corresponding to the inside of the cover 3 a current generator is situated, which comprises fixed or stator primary coils 8 that surround rotor secondary windings, secured to the rotary shaft 7.

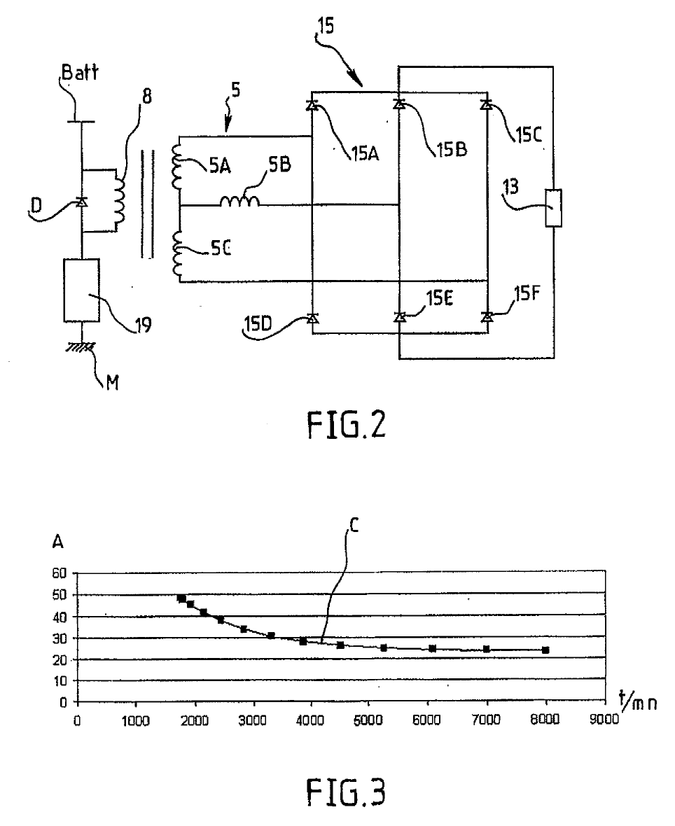

These secondary windings are shown symbolically in FIG. 2, being marked by the reference 5. These secondary windings 5 comprise here three distinct windings 5a, 5b and 5c in order to deliver a three-phase alternating current having a frequency dependent on the speed of rotation of the rotary shaft 7.

An internal jacket 9, cylindrical in shape overall, is mounted in the main casing 2, being slightly spaced apart radially from the external wall of this main casing 2 in order to define a substantially cylindrical intermediate space 10 in which a cooling liquid of this jacket 9 circulates.

This main casing, which also has a cylindrical shape overall, is provided with a channel 11 for admitting cooling liquid into the space 10 and a channel 12 for discharging cooling liquid out of this space 10.

This jacket 9 surrounds several field coils 13, which are carried by a rotor 14 rigidly fixed to the rotary shaft 7. Each field coil 13 is oriented so as to generate a radial magnetic field while having an oblong shape overall extending parallel to the shaft 7.

In a known fashion, the jacket 9 and the body of the rotor 14 are made from ferromagnetic material. Here the casing is a castable piece based on aluminium and sealing joints intervene between the casing and jacket 9, the cover 3 and the piece 4 are perforated.

The field coils 13 are supplied electrically by the rotor secondary windings 5 of the generator via a bridge rectifier carried by the rotary shaft 7. This bridge rectifier can be the one that is marked 15 in FIG. 2 and that comprises six diodes 15A-15F, in order to rectify the three-phase alternating current issuing from the secondary windings 5A-5D into direct current. This bridge rectifier can also be of another type, being for example formed from transistors of the MOSFET type.

As can be seen in FIG. 1, the rotor 14 carrying the field coils 13 has the overall shape of a hollow cylinder connected to the rotary shaft 7 by radial arms 16. This rotor 14 thus defines an annular internal space situated around the shaft 7, this internal space being ventilated by an axial fan 17 situated substantially in line with the junction of the cover 3 with the casing 2. A radial fan 18 or a deflector is situated at the opposite end of the casing 2 in order to discharge the air introduced by the fan 17.

The action on the retarder consists of supplying the primary coils 8 with an excitation current coming from the electrical system of the vehicle and in particular the battery, so that the generator delivers a current at its secondary windings 5. This current delivered by the generator then supplies the field coils 13 so as to product a resisting torque providing the retarding of the vehicle. The excitation current is injected into the primary coils 8 by means of a control box described below.

The electric power delivered by the secondary windings 5 of the generator is greater than the electric power supplying the primary coils 8 since it is the result of the magnetic field of the primary coils 8 and the work supplied by the rotary shaft. In the embodiment in FIG. 1, the shaft 7 of the retarder is connected to the transmission shaft of the vehicle wheels via the multiplier 6 acting on a secondary shaft of the gearbox.

This retarder belongs to a system comprising a control box 19 shown in FIG. 2, which is interposed for example between an electrical supply source of the vehicle and the primary coils 8. In the example in FIG. 2 the control box 19 and the primary coils 8 are mounted in series between a mass M of the vehicle and a supply Batt of the vehicle battery. As can be seen in this figure, a diode D is mounted at the terminals of the primary coils 8 so as to prevent the circulation of a reverse current in the primary coils.

This control box 19 comprises an input able to receive a control signal for the retarder, this signal representing a level of retarding torque demanded of the retarder.

This input can be connected to a lever or the like intended to be actuated directly by a driver of the vehicle in order to act on the retarder. This lever is for example able to move gradually between two extreme positions, namely a maximum position corresponding to a maximum resisting torque demand and a minimum position in which the retarder is not acted on.

When the driver places this lever in an intermediate position, the retarder is controlled by the box 19 in order to exert on the rotary shaft 7 a resisting torque proportional to the position of the lever, compared with the maximum retarding torque available. In other words, the input of the control box receives a control signal that corresponds to a value between zero and one hundred percent.

This input can also be connected to a braking control box that autonomously determines a control signal for the retarder. This braking control box is then connected to one or more braking actuators available to the driver. In this case, the driver does not act directly on the retarder but it is the braking control box that, using different parameters, controls the retarder and the traditional brakes of the vehicle.

The control box 19 of the retarder is an electronic box comprising for example a logic circuit of the ASIC type functioning at 5V, and/or a power control circuit capable of managing currents of high intensity.

When a control signal corresponding to a non-zero value is received, the control box 19 determines an excitation current intensity for the primary coils 8, taking into account the speed of rotation of the shaft 7, and injects this current into the primary coils 8 by means of its power circuits.

The rotation speed of the shaft 7 comes for example from a rotation speed sensor equipping the retarder and which is connected to the control box. However, the control box 19 can also be connected to a CAN data bus in order to recover on this bus a value representing the rotation speed of the thermal engine. The speed multiplication factor 6 is then stored in the control box 19 to allow the determination of the rotation speed of the shaft 7 with the data of the CAN bus.

The intensity of the excitation current of the primary coils 8 is determined in the control box 19 so that the generator delivers, for the rotation speed of the shaft 7 in question, an electrical supply having a power proportional to a maximum electrical power acceptable for the field coils 13, according to a proportion factor that corresponds to the control signal.

This enables the retarder to apply to the shaft 7 a resisting torque that has an amplitude proportional to the maximum torque available, according to a proportion factor that corresponds to the control signal.

It should be noted that, for the same excitation current value, the power delivered by the generator increases with the rotation speed of the shaft 7. Thus, in order to obtain a constant value of the electrical power delivered by the generator, for different speeds of the shaft 7, the excitation current must decrease when the speed of the shaft 7 increases.

This makes it possible to define, for a given maximum electrical power acceptable for the field coils 13, a curve C representing the maximum acceptable intensity in the primary coils 8 according to the speed of the shaft 7, which corresponds to the graph in FIG. 3.

As can be seen in this graph, the maximum acceptable intensity follows a decreasing curve with a horizontal asymptote. The curve C starts from the value of 50 amperes for a speed of 1500 rev/min and decreases in order to approach an asymptotic value equal to approximately 25 amperes.

Thus the application to the primary coils 8 of an excitation current having an intensity greater than that given by the curve C presents a risk of damage to the field coils 13 and/or the secondary windings 5 of the generator. An intensity situated below this curve C corresponds to a safe functioning of the retarder, that is to say without risk of damage to the field coils and/or the secondary windings 5 of the generator.

The curve C in FIG. 3 is advantageously stored in the control box. Thus, the excitation current intensity can be determined in the control box by determining, for the current rotation speed of the shaft 7, the intensity value given by the curve C, and applying to this intensity value a proportion factor corresponding to the control signal.

For example, in the case of a rotation speed of the shaft 7 equal to 3500 rev/min (revolutions per minute), the maximum acceptable intensity is equal to 30 amperes, and if the control signal for the retarder represents a demand of fifteen percent of the maximum torque available, the intensity value chosen is then 15 amperes.

The graph in FIG. 3 corresponds to a retarder that is stressed for twenty minutes, and then is no longer stressed for the following twenty minutes. This stress cycle corresponds to a certain temperature range for the field coils 13, that is to say a certain maximum electrical power acceptable for these field coils 13.

If the stress cycle of the retarder is less constraining that that of FIG. 3, that is to say if the retarder is less stressed and therefore better cooled, the temperature of the field coils 13 is lower, so that they can withstand a higher electric power than in the case of FIG. 3, so that the curve C has higher values.

Thus, in the case of a stressing corresponding to ten minutes of operation of the retarder followed by twenty minutes idle, the maximum acceptable intensity values of the curve C can be multiplied by two, which makes it possible to increase the braking torque accordingly.

Thus the control box advantageously comprises in memory data representing several curves like the curve C each corresponding to a thermal state of the retarder, this thermal state being for example determined by one or more temperature probes equipping the retarder.

In this case, the intensity of the excitation current is determined in the control box by also taking into account the thermal state of the retarder so as to increase its performance further, in particular according to the way in which it is stressed.

Data corresponding to several curves like the one in FIG. 3 can be stored in the control box 19. Each curve then corresponds to a thermal state of the retarder, that is to say for example to a range of values of a temperature representing the thermal state of the retarder.

This temperature comes for example from one or more thermal sensors equipping the retarder.

The choice of the intensity then consists of determining the curve to be taken into account, on the basis of the thermal state of the retarder, and then, from this curve, determining the intensity of the excitation current, as indicated above.

The data representing several curves like the curve C can be stored in the box, either in the form of numerical cables or in the form of a function with several variables, these variables including the speed of the shaft 7 and the temperature or temperatures signifying the state of the retarder.

The invention thus makes it possible to improve the performance and reliability of an electromagnetic retarder. It makes it possible to control it so that it in any situation generates as high a resisting torque as possible, while ensuring that the field coils will not be stressed beyond their capabilities.

Naturally the invention is not limited to the example embodiments described. In particular, the number of phases of the generator depends on the application, in a variant this number is greater than three.

1. Method of controlling a retarder (1) from a control box (19) in order to determine an excitation current intensity to be injected into primary coils (8) of a generator of the retarder (1), this retarder comprising a rotary shaft (7) carrying seconding windings (5) of the generator and field coils (13) supplied by these secondary windings (5), characterised in that it consists of taking into account the rotation speed of the rotary shaft (7) in order to chose an excitation current that is lower, the higher the rotation speed of the shaft (7).

2. Method according to claim 1, consisting of choosing an intensity for which the generator delivers, at the rotation speed in question, an electrical power lower than a maximum electrical power acceptable for the field coils (13).

3. Method according to claim 2, consisting of choosing an intensity lower than a maximum acceptable intensity dependent on the rotation speed of the shaft (7) and corresponding to the maximum electrical power acceptable for the field coils (13).

4. Method according to claim 2, in which the maximum electrical power acceptable for the field coils (13) or the maximum acceptable intensity depends on at least one temperature value signifying the thermal state of the retarder (10).

5. Method according to claim 3, consisting of taking into account the control signal of the retarder, in order to choose an intensity proportional to the maximum acceptable intensity according to a proportion factor corresponding to the control signal for the retarder.

6. System including an electromagnetic retarder comprising a rotary shaft (7) carrying secondary windings (5) of a current generator and field coils (13) supplied by the secondary windings (5) of the generator, a stator equipped with primary coils (8) of this generator, a sensor for the rotation speed of the rotary shaft (7) and a control box (19) connected to the speed sensor and/or to the temperature probe in order to take into account the rotation speed of the rotary shaft (7) in order to choose an excitation current intensity that is lower, the higher the rotation speed of the shaft (7).

7. System according to claim 6, comprising at least one temperature probe delivering a signal representing the thermal state of the retarder.

8. System according to claim 7, in which the control box (19) is connected to the temperature probe.

9. Method according to claim 3, in which the maximum electrical power acceptable for the field coils (13) or the maximum acceptable intensity depends on at least one temperature value signifying the thermal state of the retarder (10).
